(19) United States
(12) Patent Application Publication
(10) Pub. No.: US 2026/0023201 A1
(43) Pub. Date: Jan. 22, 2026

(54) OPTICAL ELEMENT

(71) Applicant: Panasonic Intellectual Property Management Co., Ltd., Osaka (JP)

(72) Inventors: KEIGO MASUDA, Osaka (JP); EIJI TAKEDA, Osaka (JP)

(21) Appl. No.: 19/342,756

(22) Filed: Sep. 29, 2025

Related U.S. Application Data
(63) Continuation of application No. PCT/JP2024/019191, filed on May 24, 2024.

(30) Foreign Application Priority Data
Jun. 29, 2023 (JP) 2023-106649

(51) Int. Cl. G02B 5/28; G02B 5/20

(52) U.S. Cl. CPC G02B 5/281; G02B 5/201; G02B 5/207

(57) ABSTRACT

An optical element includes a plurality of microstructures that are two-dimensionally arranged and each of which generates a phase difference in an incident light beam and emits the incident light beam as a transmitted light beam. Phases of transmitted light beams from two adjacent microstructures among the plurality of microstructures differ from each other. The optical element has a transmittance that is determined as transmitted light beams each from a corresponding one of the plurality of microstructures interfere with each other.

### BACKGROUND

### 1. Technical Field

The present disclosure relates to an optical element.

### 2. Description of the Related Art

In recent years, research and development of an optical element including a microstructure called a metasurface are in progress (see, for example, Japanese Unexamined Patent Application Publication (Translation of PCT Application) No. 2019-516128 and Park et al., “Structural Color Filters Enabled by a Dielectric Metasurface Incorporating Hydrogenated Amorphous Silicon Nanodisks”, Scientific Reports 7, Article number: 2556 May 2017).

### SUMMARY

The optical element including the metasurface described in Park et al., utilizes resonance that occurs in the microstructure. The resonance is Mie resonance, guided-mode resonance, plasmon resonance, or the like, each of which has a feature such that a wavelength band in which the resonance occurs is narrow. Therefore, with the optical element including the metasurface described in Park et al., the wavelength dependency of optical characteristics such as transmission, reflection, and absorption is high. That is, with the optical element described in Park et al., desirable optical characteristics are realized only in a narrow wavelength band, and it is difficult to realize desirable optical characteristics for wavelength components in a broad band.

One non-limiting and embodiment provides an optical element with which design change of optical characteristics is easy and that has low wavelength dependency.

In one general aspect, the techniques disclosed here feature an optical element including a plurality of microstructures that are two-dimensionally arranged and each of which generates a phase difference in an incident light beam and emits the incident light beam as a transmitted light beam. Phases of transmitted light beams from two adjacent microstructures, among the plurality of microstructures, differ from each other. The optical element has a transmittance that is determined as transmitted light beams each from a corresponding one of the plurality of microstructures interfere with each other.

With the present disclosure, it is possible to provide an optical element with which design change of optical characteristics is easy and that has low wavelength dependency.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a plan view of an optical element according to an embodiment;

FIG. 2 is an enlarged plan view of the optical element illustrated in FIG. 1;

FIG. 3 is a perspective view of one unit cell included in the optical element according to the embodiment;

FIG. 4 is a cross-sectional view of one unit cell included in the optical element according to the embodiment;

FIG. 5 is a view for illustrating the transmission characteristics of microstructures included in the optical element according to the embodiment;

FIG. 6 is a graph illustrating the relationship between the diameter of a microstructure included in the optical element according to the embodiment and the phase of a transmitted light beam;

FIG. 7 is a graph illustrating the relationship between the diameter and the transmittance of a microstructure included in the optical element according to the embodiment;

FIG. 8 is a table showing an example of combination of microstructures of the optical element according to the embodiment;

FIG. 9 is a view for illustrating the transmission characteristics of the optical element including the combination of microstructures shown in FIG. 8;

FIG. 10 is a graph illustrating the relationship among the diameter of a microstructure included in the optical element according to the embodiment, the transmittance of the optical element, and the phase difference relative to an adjacent microstructure;

FIG. 11 is a graph illustrating the wavelength dependency of the optical element according to the embodiment;

FIG. 12 is an enlarged plan view of an optical element according to a first modification of the embodiment; and

FIG. 13 is a cross-sectional view of an optical element according to a second modification of the embodiment.

### DETAILED DESCRIPTIONS

### Overview of Present Disclosure

An optical element according to a first aspect of the present disclosure includes a plurality of microstructures that are two-dimensionally arranged and each of which generates a phase difference in an incident light beam and emits the incident light beam as a transmitted light beam. Phases of transmitted light beams from two adjacent microstructures, among the plurality of microstructures, differ from each other. The optical element has a transmittance that is determined as transmitted light beams each from a corresponding one of the plurality of microstructures interfere with each other.

Thus, because interference of the transmitted light beams emitted from the plurality of microstructures is used, the wavelength dependency is low compared with a case where resonance is used. Therefore, it is possible to realize the optical element having low wavelength dependency. Moreover, for example, by changing design such as the arrangement of a plurality of microstructures, it is possible to easily perform design change of optical characteristics.

An optical element according to a second aspect of the present disclosure is the optical element according to the first aspect, in which the plurality of microstructures include a plurality of first microstructures that are two-dimensionally and periodically arranged and each of which generates a first phase difference in the incident light beam and emits the incident light beam as a first transmitted light beam, and a plurality of second microstructures that are two-dimensionally and periodically arranged and each of which generates a second phase difference in the incident light beam and emits the incident light beam as a second transmitted light beam. The second phase difference differs from the first phase difference. The plurality of second microstructures are each disposed between two of the first microstructures that are adjacent to each other.

Thus, because two types of microstructures are periodically arranged adjacent to each other, it is possible to uniformly cause interference between transmitted light beams in a range in which the microstructures are provided. Because it is possible to set the phase difference between transmitted light beams to a desirable value, it is possible to easily perform design change of the optical characteristics of the optical element.

An optical element according to a third aspect of the present disclosure is the optical element according to the second aspect, in which the first microstructures and the second microstructures differ from each other in at least one of shape, arrangement period, and material.

Thus, it is possible to easily adjust the phase difference of transmitted light beams. It is possible to increase the precision in setting the transmittance of the optical element, and it is possible to realize the optical element that meets the demands of users and the like.

An optical element according to a fourth aspect of the present disclosure is the optical element according to any one of the first to third aspects, in which

$$H \geq \frac{λ}{2 \vert {n}_{b} - {n}_{p} \vert}$$

is satisfied, where H is a height of the microstructures, λ is a wavelength of the incident light beam, nₚ is a refractive index of the microstructures, and n_{b} is a refractive index of a region surrounding the microstructures.

Thus, the microstructures can reliably have a height H that is necessary to make the transmittance of the incident light beam having a wavelength λ substantially 0. Because the range in which transmittance can be set is widened, it is possible to realize the optical element that meets the demands of users and the like.

An optical element according to a fifth aspect of the present disclosure is the optical element according to any one of the first to fourth aspects, in which the plurality of microstructures are arranged so that a distance between adjacent microstructures is less than a wavelength of the incident light beam.

Thus, because it is possible to cause transmitted light beams from adjacent microstructures to interfere with each other, it is possible to increase the controllability of transmittance. That is, it is possible to increase the precision in setting the transmittance of the optical element, and it is possible to realize the optical element that meets the demands of users and the like.

An optical element according to a sixth aspect of the present disclosure is the optical element according to any one of the first to fifth aspects, in which a wavelength of the incident light beam is greater than or equal to 8 μm and less than or equal to 14 μm.

Thus, it is possible to realize the optical element that is suitable for thermal imaging.

An optical element according to a seventh aspect of the present disclosure is the optical element according to the sixth aspect, in which the transmittance is less than or equal to 10%.

Thus, it is possible to realize the optical element having a sufficiently low transmittance with respect to far infrared radiation in a wide wavelength band. For example, it is possible to use the optical element for a sensor that attenuates and then detects intense far infrared radiation, a sensor that detects light in a necessary wavelength band by removing unnecessary far infrared radiation, and the like.

An optical element according to an eighth aspect of the present disclosure is the optical element according to the sixth or seventh aspect, in which an absorptance of the optical element with respect to the incident light beam is less than or equal to 5%.

Thus, it is possible to realize the optical element having a sufficiently low absorptance with respect to far infrared radiation in a wide wavelength band. It is possible to suppress generation of thermal energy due to absorption of light. Because it is possible to suppress deterioration of the optical element due to heat, it is possible to realize the optical element having high reliability.

An optical element according to a ninth aspect of the present disclosure is the optical element according to any one of the first to eighth aspects, in which the plurality of microstructures are each a protrusion or a recess, and a shape of the protrusion or the recess is a columnar body, a conical body, or a combination of a columnar body and a conical body.

Thus, because the freedom in selection of shape is high, it is possible to realize the optical element that meets the demands of users and the like.

An optical element according to a tenth aspect of the present disclosure is the optical element according to any one of the first to ninth aspects, in which the plurality of microstructures include, as a main component, one or more selected from the group consisting of silicon, germanium, chalcogenide, chalcohalide, zinc sulfide, zinc selenide, fluoride, thallium halide, sodium chloride, potassium chloride, potassium bromide, cesium iodide, and plastic.

Thus, because it is possible to suppress reflection at a surface of the optical element and attenuation inside the optical element when the incident light beam is far infrared radiation beam, the range in which transmittance can be set is widened. Because it is possible to realize the optical element having a desirable transmittance that meets the demands, it is possible to increase the versatility of the optical element. Moreover, because it is possible apply a similar principle for any material having transmittance greater than or equal to a certain level with respect to the incident light beam, freedom in selection of material is increased without depending on material property.

An optical element according to an eleventh aspect of the present disclosure is the optical element according to any one of the first to tenth aspects, in which the plurality of microstructures are provided on a main surface of a silicon substrate whose crystal orientation is (100), (110), or (111).

Thus, because it is possible to utilize general semiconductor processing technology applicable to silicon, it is possible to increase the precision in shape and arrangement of the plurality of microstructures. Thus, it is possible to realize the optical element having a desirable transmittance that meets the demands.

An optical element according to a twelfth aspect of the present disclosure is the optical element according to the second or third aspect, in which the plurality of microstructures further include a plurality of third microstructures that are two-dimensionally and periodically arranged and each of which generates a third phase difference in the incident light beam and emits the incident light beam as a third transmitted light beam, wherein the third phase difference differs from each of the first phase difference and the second phase difference, and the plurality of third microstructures are each disposed between the first microstructure and the second microstructure that are adjacent thereto.

Thus, because three types of microstructures are used, it is possible to cause different interferences in accordance with the combination of the microstructures. Therefore, it is possible to increase the controllability of transmittance. That is, it is possible to increase the precision in setting the transmittance of the optical element, and it is possible to realize the optical element that meets the demands of users and the like.

Hereafter, embodiments will be described in detail with reference to the drawings.

The embodiments described below each represent a general or specific example. The values, shapes, constituent elements, arrangements of constituent elements, positions and connection configurations of constituent elements, and the like described in the following embodiments are examples, and do not limit the present disclosure. Among the constituent elements in the embodiments, constituent elements that are not described in the independent claims are optional constituent elements.

Each figure is a schematic view and is not necessarily drawn strictly. Accordingly, for example, scales and the like in the figures do not necessarily coincide. In the figures, substantially the same configurations are denoted by the same numerals, and redundant descriptions thereof may be omitted or simplified.

In the present specification, terms that represent the relationships between elements such as “parallel” and “perpendicular”, terms that represent the shapes of elements such as “cylinder” and “prism”, and numerical ranges not only have strict meanings but also have substantially equivalent meanings including, for example, a difference of several %.

In the present specification and drawings, x axis, y axis, and z axis are the three axes of a three-dimensional orthogonal coordinate system. In the present specification, unless otherwise noted, “plan view” refers to a view as seen in a direction perpendicular to the main surface of a substrate.

In the present specification, the terms “upward” and “downward” do not represent the upward direction (vertically above) and the downward direction (vertically below) in absolute spatial recognition. In the following description, the side on which a plurality of microstructures are provided with respect to a substrate is regarded as “upward”. This “upward” is defined as the positive direction of the z axis. The z axis extends in a direction perpendicular to the main surface of a substrate. The terms “above” and “below” are used, not only when two constituent elements are disposed with a space therebetween and another constituent element is present between the two constituent elements, but also when two constituent elements are disposed very close to each other and the two constituent elements are in close contact with each other.

In the present specification, unless otherwise noted, an ordinal number, such as “first” or “second”, does not mean the number of elements or the order of elements, and is used in order to avoid confusion between similar elements and discriminate between the elements.

In the present specification, the term “light” is used not only for visible light but also for invisible light. Visible light is light whose wavelength is greater than or equal to 380 nm and less than or equal to 780 nm. Invisible light includes ultraviolet radiation, infrared radiation, far infrared radiation, and radio wave. Ultraviolet radiation is light whose wavelength is greater than or equal to 10 nm and less than or equal to 380 nm. Infrared radiation is light whose wavelength is greater than or equal to 780 nm and less than or equal to 3000 nm (=3 μm). Far infrared radiation is light (electromagnetic radiation) whose wavelength is greater than or equal to 3 μm and less than or equal to 1000 μm (=1 mm). Radio wave is electromagnetic radiation whose wavelength is greater than or equal to 1 mm.

### Embodiments

### Configuration

First, the configuration of an optical element according to an embodiment will be described.

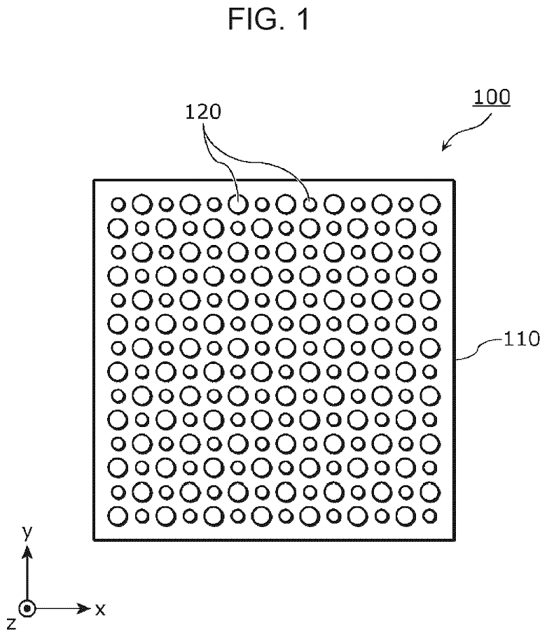

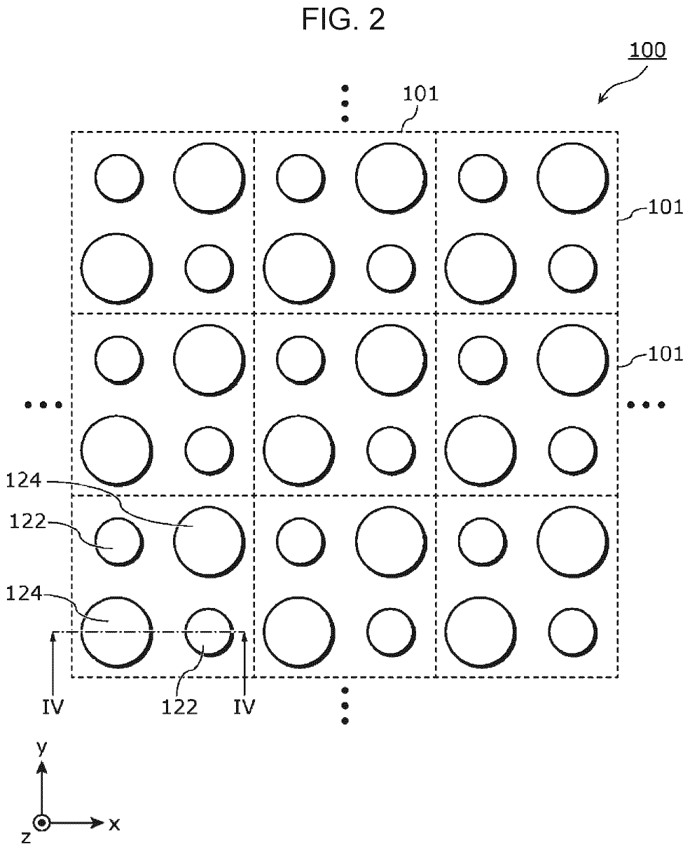

FIG. 1 is a plan view of an optical element 100 according to the present embodiment. FIG. 2 is an enlarged plan view of the optical element 100 illustrated in FIG. 1.

The optical element 100 is an optical filter that transmits an incident light beam with a predetermined transmittance and emits the incident light beam as a transmitted light beam. The optical element 100 has a transmittance that is determined as transmitted light beams emitted from a plurality of microstructures 120 interfere with each other. The transmittance is the ratio of the radiant exitance of the transmitted light beam to the radiant exitance of the incident light beam. The transmittance is represented by a value that is greater than or equal to 0 and less than or equal to 1 (greater than or equal to 0% and less than or equal to 100%). The transmittance of the optical element 100 can be set to a small value less than or equal to 10%. That is, the optical element 100 need not practically transmit light in a predetermined wavelength band. Hereafter, an example in which the incident light beam is far infrared radiation will be described. However, this is not a limitation. The incident light beam may be visible light, ultraviolet radiation, infrared radiation, or radio wave.

As illustrated in FIG. 1, the optical element 100 includes a substrate 110 and the plurality of microstructures 120 provided on a main surface of the substrate 110.

The substrate 110 is an example of a support member that supports the plurality of microstructures 120. The substrate 110 is made of, for example, a material including silicon as a main component. To be specific, the substrate 110 is a silicon substrate having a main surface with a crystal orientation (100). The crystal orientation of the main surface of the silicon substrate may be (110) or (111). The substrate 110 may be made of a material different from silicon.

The thickness of the substrate 110 is, for example, 500 μm. As illustrated in FIG. 1, the shape of the substrate 110 is a square, and the size of the substrate 110 is, for example, 8 mm×8 mm. The plurality of microstructures 120 are two-dimensionally arranged on the main surface of the substrate 110. The thickness, the shape, and the size of the substrate 110 are examples and are not limited to these.

The plurality of microstructures 120 are two-dimensionally arranged. As illustrated in FIG. 1, the plurality of microstructures 120 are provided on the entire region of the main surface of the substrate 110. However, this is not a limitation. For example, the plurality of microstructures 120 may be provided only on a partial region, such as a circular region, of the main surface of the substrate 110.

The plurality of microstructures 120 each generates a phase difference in an incident light beam and emits the incident light beam as a transmitted light beam. The phases of transmitted light beams from two adjacent microstructures 120, among the plurality of microstructures 120, differ from each other. The plurality of microstructures 120 include microstructures that differ in at least one of shape, arrangement period, and material. To be specific, as illustrated in FIG. 2, the plurality of microstructures 120 includes a plurality of first microstructures 122 and a plurality of second microstructures 124. The plurality of first microstructures 122 is two-dimensionally and periodically arranged. The plurality of second microstructures 124 is two-dimensionally and periodically arranged. The term “periodical arrangement” means arrangement at regular intervals (equal arrangement periods) in a plurality of directions.

Two first microstructures 122 and two second microstructures 124 constitute one unit cell 101. A plurality of unit cells 101 is arranged in a matrix pattern to constitute the optical element 100.

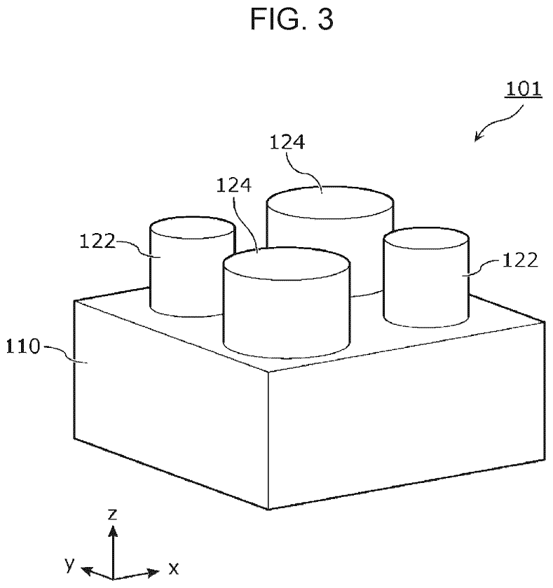

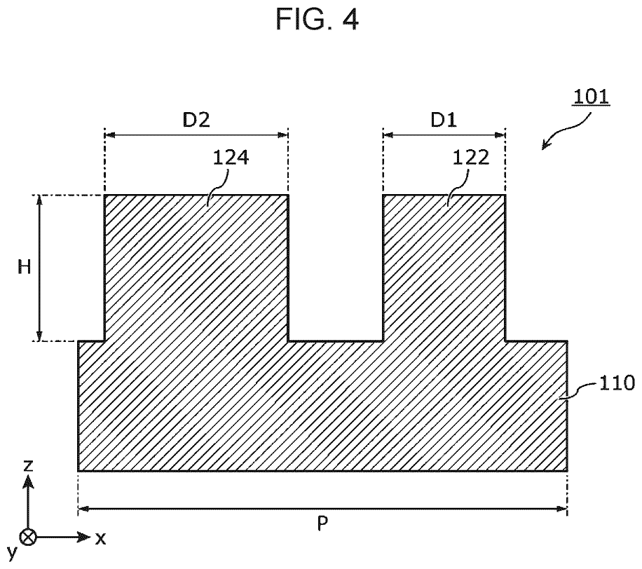

FIG. 3 is a perspective view of one unit cell 101 included in the optical element 100 according to the present embodiment. FIG. 4 is a cross-sectional view of one unit cell 101 included in the optical element 100 according to the present embodiment. To be specific, FIG. 4 illustrates a cross section taken along line IV-IV of FIG. 2.

The shape of the unit cell 101 in plan view is a square. In the present specification, the x axis and the y axis extend in directions parallel to respective sides of the unit cell 101. In one unit cell 101, in plan view, the first microstructure 122 and the second microstructure 124 are alternately arranged in a 2×2 matrix pattern. In plan view, two first microstructures 122 are arranged on one of the two diagonal lines of the unit cell 101. Two second microstructures 124 are arranged on the other of the two diagonal lines of the unit cell 101. To be more specific, when the unit cell 101 is divided into four equal squares in plan view, two first microstructures 122 and two second microstructures 124 are arranged so that the geometrical centers (centroids) thereof coincide with the centers of the four squares. Thus, when the plurality of unit cells 101 is arranged in a matrix pattern, the first microstructures 122 and the second microstructures 124 are alternately arranged at equal arrangement periods in each of the x-axis direction and the y-axis direction. That is, the plurality of second microstructures 124 is each disposed between adjacent first microstructures 122.

In the present embodiment, as illustrated in FIGS. 3 and 4, the first microstructure 122 and the second microstructure 124 are each a protrusion protruding from the main surface of the substrate 110. The shape of the protrusion is a columnar body (also called a pillar). To be specific, the first microstructure 122 and the second microstructure 124 are cylindrical bodies having circular bottom surfaces with different diameters (maximum widths).

To be more specific, as illustrated in FIG. 4, the first microstructure 122 is a cylindrical body having a bottom surface with a diameter D1 and a height H. The second microstructure 124 is a cylindrical body having a bottom surface with a diameter D2 and a height H. In the present embodiment, the height of the first microstructure 122 and the height of the second microstructure 124 are the same. However, these may be different.

As illustrated in FIG. 4, P is the length of one side of the unit cell 101. The length of one side of the unit cell 101 is the arrangement period of the first microstructures 122. The arrangement period, which is also called the pitch, is the center-to-center distance between the first microstructures 122 that are adjacent to each other in the row direction (x-axis direction) or in the column direction (y-axis direction). In the present embodiment, the length of one side of the unit cell 101 is also the arrangement period of the second microstructures 124. That is, the arrangement period of the first microstructures 122 and the arrangement period of the second microstructures 124 are the same. The arrangement period may differ between the x-axis direction and the y-axis direction. The arrangement period of microstructures may be regarded as the center-to-center distance between microstructures that are arranged in the diagonal direction in the unit cell 101.

In the present embodiment, the plurality of microstructures 120 is arranged so that the distance between adjacent microstructures 120 is less than the wavelength of an incident light beam. The distance between adjacent microstructures 120 is the center-to-center distance between adjacent microstructures 120, which is, to be specific, the center-to-center distance between the first microstructure 122 and the second microstructure 124 that are adjacent to each other in the x-axis direction or in the y-axis direction. The distance between adjacent microstructures 120 is a length that is half the length of one side of the unit cell 101, that is, P/2. P/2<λ is satisfied, where λ is the wavelength of an incident light beam. The wavelength λ of an incident light beam is, for example, greater than or equal to 8 μm and less than or equal to 14 μm. Therefore, the distance between adjacent microstructures 120 is shorter than a predetermined value in the range of greater than or equal to 8 μm and less than or equal to 14 μm. Thus, it is possible to cause transmitted light beams from adjacent microstructures 120 to interfere with each other.

The diameter (maximum width) of the plurality of microstructures 120 is shorter than the distance between adjacent microstructures 120. To be specific, D1<P/2 and D2<P/2 are satisfied. The diameters D1 and D2 are each shorter than a predetermined value in the range of greater than or equal to 8 μm and less than or equal to 14 μm.

The height H of the microstructure 120 satisfies, for example, the following expression (1). However, this is not a limitation.

$$H \geq \frac{λ}{2 \vert {n}_{b} - {n}_{p} \vert} \qquad ( 1 )$$

Here, nₚ is the refractive index of the microstructure 120. n_{b} is the refractive index of a region surrounding the microstructure 120. In the present embodiment, the surface of the microstructure 120 is not covered with another member and is in contact with air. Therefore, no can be regarded as the refractive index of air (to be specific, approximately 1).

The right-hand side of expression (1) corresponds to the minimum value Hₘᵢₙ of height that is necessary to make the transmittance of the optical element 100 substantially 0%. That is, when the height H of the microstructure 120 satisfies expression (1), it is possible to make the transmittance be a desirable value from 0%. A method of calculating the right-hand side of expression (1) will be described below.

The plurality of microstructures 120 includes, as a main component, one or more selected from the group consisting of silicon, germanium, chalcogenide, chalcohalide, zinc sulfide, zinc selenide, fluoride, thallium halide, sodium chloride, potassium chloride, potassium bromide, cesium iodide, and plastic. In the present specification, the term “main component” means a component having the highest proportion among constituent materials in terms of mole percent. It is possible to use various resins as the plastic, and, for example, polyethylene can be used.

In the present embodiment, the substrate 110 and the plurality of microstructures 120 is integrally formed from the same material. To be specific, the optical element 100 can be manufactured by processing one base material.

For example, the optical element 100 can be manufactured by using a general semiconductor processing technology such as lithography. First, as the substrate 110, a silicon substrate having a main surface whose crystal orientation is (100) is prepared. Next, a positive resist is applied to the main surface of the silicon substrate by using a method such as spin coating. Next, a desirable position is irradiated with a light beam or an electron beam, and then development is performed. Thus, the resist at the position irradiated with the light beam or the electron beam is removed. The silicon substrate is etched by using, for example, a reactive ion etching technology using an etching gas such as SF₆ gas. Thus, the main surface of the silicon substrate at the position from which the resist has been removed is etched. The etched-away portion is the space between the plurality of microstructures 120. That is, portions that remain without being etched are the plurality of microstructures 120. Subsequently, the resist remaining on the main surface of the silicon substrate is removed by performing a wet process using a resist stripping solution or the like or a dry process using O₂ ashing or the like. Through these steps, it is possible to manufacture the optical element 100 including the substrate 110 and the plurality of microstructures 120.

A method of manufacturing the optical element 100 is not limited to the method described above. For example, the plurality of microstructures 120 may be formed by performing selective epitaxial growth of silicon on the main surface of a silicon substrate. Alternatively, the microstructures 120 may be formed by forming a film of a constituent material of the microstructures 120 on the main surface of a silicon substrate and then performing etching. In accordance with the constituent material, it is possible to form the film by using various film-forming technologies such as epitaxial growth, application, vapor deposition, and sputtering.

### Optical Characteristics

Next, the optical characteristics of the microstructure 120 will be described.

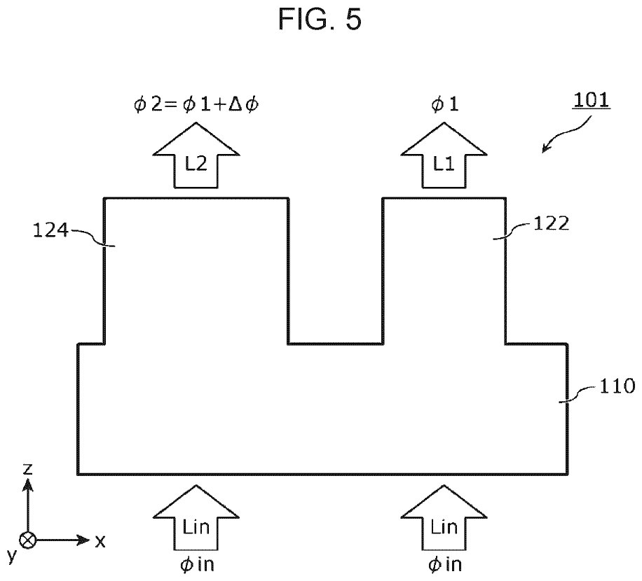

FIG. 5 is a view for illustrating the transmission characteristics of the first microstructure 122 and the second microstructure 124 included in the optical element 100 according to the present embodiment. Although FIG. 5 illustrates the same cross section as FIG. 4, diagonal hatching representing the cross section is omitted.

As illustrated in FIG. 5, an incident light beam Lin is incident on the lower surface (the main surface on the negative side of the z axis) of the substrate 110 of the optical element 100. For example, the incident light beam Lin is perpendicularly incident on the entirety of the lower surface of the substrate 110. However, the incident light beam Lin may be incident on only a part of the lower surface of the substrate 110 or may be diagonally incident on the lower surface.

After passing through the substrate 110, the incident light beam Lin passes through the first microstructure 122 and the second microstructure 124 and is emitted as a transmitted light beam L1 and a transmitted light beam L2 respectively. To be specific, the first microstructure 122 generates a first phase difference in the incident light beam Lin and emits the incident light beam Lin as the transmitted light beam L1. For example, the first phase difference is φ1−φin, where φ1 is the phase of the transmitted light beam L1 and pin is the phase of the incident light beam Lin.

The second microstructure 124 generates a second phase difference in the incident light beam Lin and emits the incident light beam Lin as the transmitted light beam L2. For example, the second phase difference is φ2−φin, where φ2 is the phase of the transmitted light beam L2. In the present embodiment, the second phase difference differs from the first phase difference. In other words, the phase φ2 of the transmitted light beam L2 differs from the phase φ1 of the transmitted light beam L1.

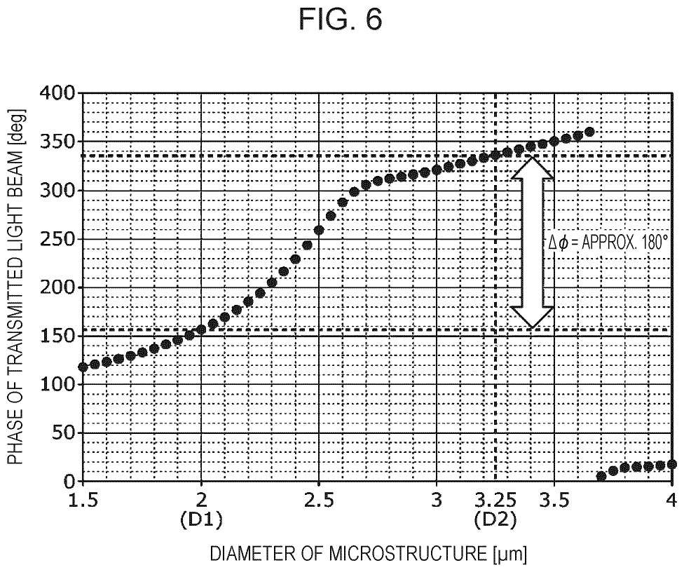

FIG. 6 is a graph illustrating the relationship between the diameter of the microstructure 120 included in the optical element 100 according to the present embodiment and the phase of a transmitted light beam. In FIG. 6, the horizontal axis represents the diameter of the microstructure 120 (unit: μm), and the vertical axis represents the phase of a transmitted light beam (unit: deg (°)).

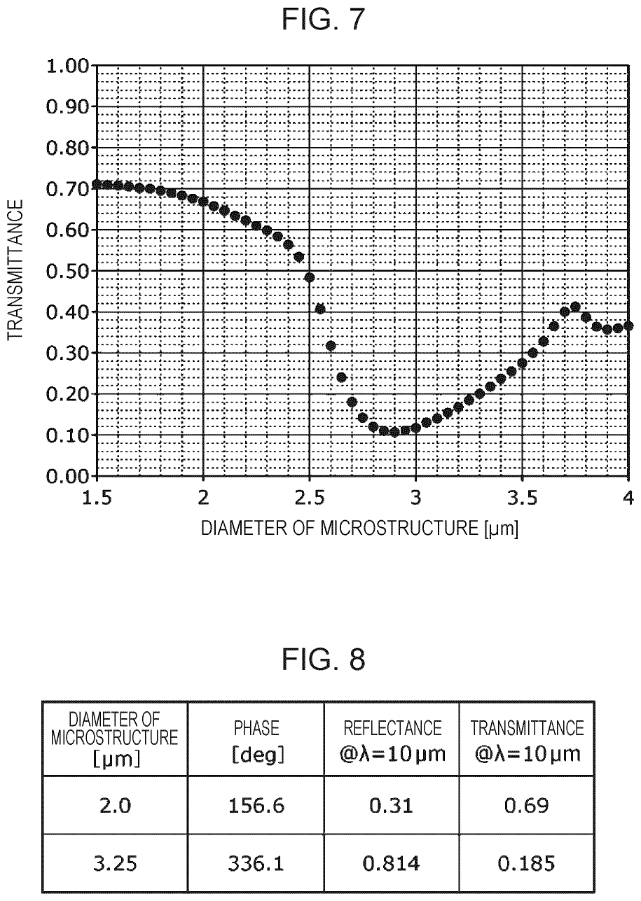

FIG. 6 is obtained by modulating the diameter of the microstructure 120 in the range of 1.5 μm to 4 μm in a state in which the microstructures 120 of one type having a height H of 3.75 μm are arranged at an arrangement period P of 4.6 μm. The wavelength 2 of an incident light beam is 10 μm. The same applies to FIGS. 7 and 8 described below.

As illustrated in FIG. 6, the phase of a transmitted light beam from the microstructure 120 is represented by a function of the diameter of the microstructure 120. That is, by setting the values of the diameters D1 and D2 to predetermined values, it is possible to uniquely determine the phase φ1 of the transmitted light beam L1 from the first microstructure 122 and the phase φ2 of the transmitted light beam L2 from the second microstructure 124. The phases φ1 and φ2 are respectively determined by the first phase difference that the first microstructure 122 generates and the second phase difference that the second microstructure 124 generates. The difference between the first phase difference and the second phase difference is the same as the phase difference between φ1 and φ2.

When the diameter is in the range of greater than or equal to 1.5 μm and less than or equal to 4 μm, the phase of the transmitted light beam has a positive correlation with the diameter. The phase exceeding 360° is illustrated by converting the phase so that the phase falls within the range of greater than or equal to 0° and less than or equal to 360°. In determining the diameter D1 of the first microstructure 122 and the diameter D2 of the second microstructure 124, as the difference between D1 and D2 decreases, the difference Δφ between the phase differences respectively generated by the first microstructure 122 and the second microstructure 124 decreases. That is, the difference Δφ between the phase φ1 of the transmitted light beam L1 from the first microstructure 122 and the phase φ2 of the transmitted light beam L2 from the second microstructure 124 decreases. For example, when D1=2 μm and D2=3.25 μm, the difference Δφ is approximately 180°. A combination of D1 and D2 that makes Δφ=180° is not limited to this.

FIG. 7 is a graph illustrating the relationship between the diameter and the transmittance of the microstructure 120 included in the optical element 100 according to the present embodiment. In FIG. 7, the horizontal axis represents the diameter D1 or D2 of the microstructure 120 (unit: μm) and the vertical axis represents the transmittance of the microstructure 120. The transmittance is the transmittance with respect to light having a wavelength of 10 μm.

As illustrated in FIG. 7, the transmittance of the microstructure 120 is represented by a function of the diameter of the microstructure 120. That is, by setting the values of the diameters D1 and D2 to predetermined values, it is possible to uniquely determine the transmittance of each of the first microstructure 122 and the second microstructure 124. In the example illustrated in FIG. 7, the transmittance of the microstructure 120 can have a value in the range of 0.10 to 0.70 in accordance with the diameter.

FIG. 8 is a table showing an example of combination of the microstructures 120 of the optical element 100 according to the present embodiment. The table shows the phases of transmitted light beams and the reflectance and the transmittance of the microstructures when D1=2.0 μm and D2=3.25 μm. As illustrated in FIG. 8, by making D1=2.0 μm and D2=3.25 μm, it is possible to make the phase difference Δφ between the phase φ1 of the transmitted light beam L1 and the phase φ2 of the transmitted light beam L2 approximately 180°.

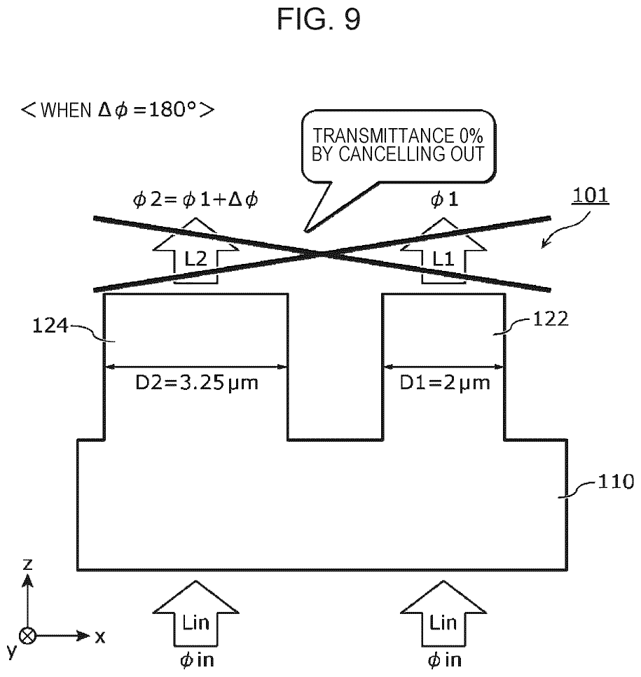

FIG. 9 is a view for illustrating the transmission characteristics of the optical element 100 including the combination of microstructures 120 shown in FIG. 8. When the phase difference Δφ between the transmitted light beams L1 and L2 respectively from the first microstructure 122 and the second microstructure 124 that are adjacent to each other is approximately 180° as illustrated in FIG. 8, the transmitted light beam L1 and the transmitted light beam L2 interfere with each other and cancel out each other. As a result, it is possible to create a situation in which the optical element 100 does not practically transmit the incident light beam Lin. That is, it is possible to make the transmittance of the optical element 100 a sufficient small value that is less than or equal to 10%. Moreover, control of transmittance to a desirable value is realized.

In this way, by making the phase difference Δφ between the transmitted light beams L1 and L2 approximately 180°, it is possible to make the transmittance of the optical element 100 sufficiently small.

Based on conditions that make the transmittance substantially 0, it is possible to determine the minimum value Hₘᵢₙ of the height H of the microstructure 120 (to be specific, the right-hand side of expression (1)).

The phase difference Δφ is represented by the absolute value of φ1−φ2. The phases φi (i=1, 2) are represented by the following expression (2).

$$ϕ i = \frac{2 π}{λ} \cdot {n}_{effi} \cdot H \qquad ( 2 )$$

In expression (2), n_{effi} (i=1, 2) is the effective refractive index of the microstructure 120.

When Δφ=φ1−φ2=π(180°), the height H at this time is derived from expression (2) and represented by the following expression (3).

$$H = \frac{λ}{2 \vert {n}_{eff 1} - {n}_{eff 2} \vert} \qquad ( 3 )$$

Based on expression (3), the minimum value Hₘᵢₙ of the height H of the microstructure 120, which corresponds to a case where n_{eff1}=n_{b} and n_{eff2}=nₚ, is represented by expression (4).

$${H}_{m i n} = \frac{λ}{2 \vert {n}_{b} - {n}_{p} \vert} \qquad ( 4 )$$

When the microstructure 120 is made of silicon and air surrounds the microstructure 120, the refractive index of silicon nₚ=3.42 and the refractive index of air n_{b}=1. When the wavelength λ of an incident light beam=10 μm, Hₘᵢₙ is approximately equal to 2.1 μm from expression (4). By making the height H of the microstructure 120 Hₘᵢₙ greater than or equal to approximately 2.1 μm based on expression (1), it is possible to make the transmittance of the optical element 100 greater than or equal to 0.

In FIGS. 8 and 9, an example in which the transmittance is made sufficiently small is illustrated. Regarding the optical characteristics of the optical element 100, it is also possible to adjust the transmittance by adjusting the shapes, the arrangement periods, and the materials of the first microstructure 122 and the second microstructure 124. For example, when the shape of the first microstructure 122 is a cylindrical body having a diameter D1=2 μm, it is possible to change the transmittance of the optical element 100 by modulating the diameter D2 of the second microstructure 124.

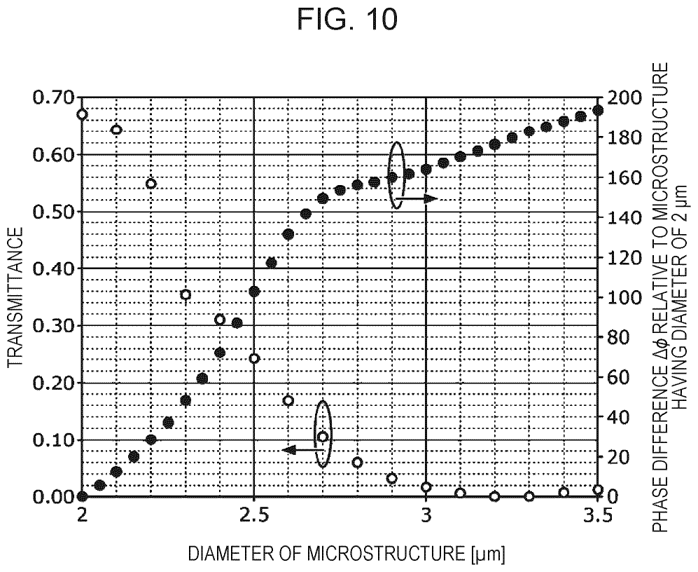

FIG. 10 is a graph illustrating the relationship among the diameter of the microstructure 120 included in the optical element 100 according to the present embodiment, the transmittance of the optical element 100, and the phase difference Δφ relative to an adjacent microstructure 120. In FIG. 10, the horizontal axis represents the diameter of the second microstructure 124 (unit: μm). The left vertical axis represents the transmittance of the optical element 100. The right vertical axis represents the phase difference Δφ between the transmitted light beam L2 from the second microstructure 124 and the transmitted light beam L1 from the first microstructure 122 having a diameter of 2 μm. White circles in FIG. 10 represent transmittances plotted against the left vertical axis. Black circles represent phase differences Δφ plotted against the right vertical axis.

As illustrated in FIG. 10, as the diameter D2 of the second microstructure 124 becomes closer to 2 μm (=D1), the transmittance of the optical element 100 becomes greater. As the diameter D2 of the second microstructure 124 increases further than 2 μm, the transmittance of the optical element 100 becomes smaller. When the diameter D2 becomes approximately 3.25 μm, the transmittance of the optical element 100 becomes substantially 0.

In this way, it is possible to set the transmittance of the optical element 100 to a desirable value by setting the diameter D2 of the second microstructure 124 to a predetermined value. The same applies to a case where the diameter D1 of the first microstructure 122 is modulated. Instead of changing the diameters D1 and D2, it is also possible to set the transmittance of the optical element 100 to a predetermined value by changing the shape, the arrangement period, and the material (refractive index).

Although a case where the wavelength λ is 10 μm has been described as an example, the optical element 100 can realize a similar transmittance with respect to a wavelength in the vicinity of 10 μm. That is, it is possible to reduce the transmittance in a broad band.

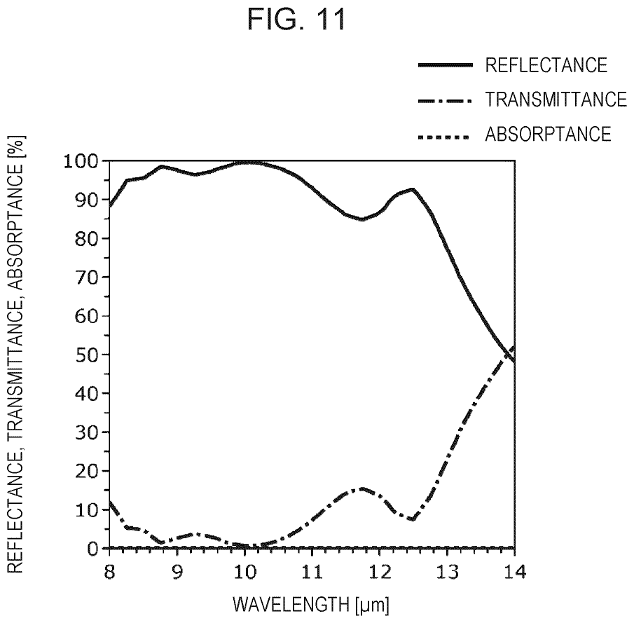

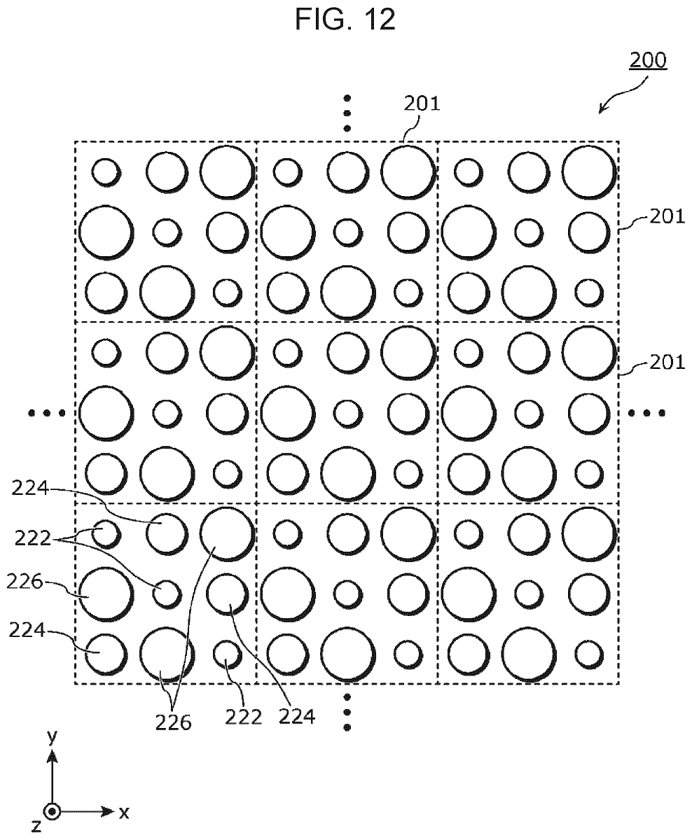

FIG. 11 is a graph illustrating the wavelength dependency of the optical element 100 according to the present embodiment. In FIG. 11, the horizontal axis represents the wavelength λ of an incident light beam (unit: μm), and the vertical axis represents the light reflectance, transmittance, and absorptance (each unit: %).

FIG. 11 illustrates the wavelength dependency of the optical characteristics of the optical element 100 when D1=2 μm, D2=3.25 μm, H=3.75 μm, and P/2=4.6 μm. The main component of the optical element 100 is silicon. As illustrated in FIG. 11, the light absorptance is approximately 0% when the wavelength λ of an incident light beam is in the range of greater than or equal to 8 μm and less than or equal to 14 μm. Therefore, when the wavelength λ of an incident light beam is in the range of greater than or equal to 8 μm and less than or equal to 14 μm, the sum of the light reflectance and transmittance is substantially 1.

The transmittance is less than or equal to approximately 0.5 (=50%) when the wavelength λ of an incident light beam is in the range of greater than or equal to 8 μm and less than or equal to 14 μm. In this way, the optical element 100 such that transmittance can be reduced and reflection is dominant in a wide wavelength band is realized. The transmittance is less than or equal to approximately 0.2 (=20%) when the wavelength λ of an incident light beam is in the range of greater than or equal to 8 μm and less than or equal to 13 μm. The transmittance is less than or equal to approximately 0.1 (=10%) when the wavelength λ of an incident light beam is in the range of greater than or equal to 8 μm and less than or equal to 11 μm. In this way, the optical element 100 that does not practically transmit light in a wide wavelength band is realized.

### Modifications

Next, modifications of the embodiment described above will be described. Hereafter, differences from the embodiment will be mainly described, and descriptions of common points will be omitted or simplified.

### First Modification

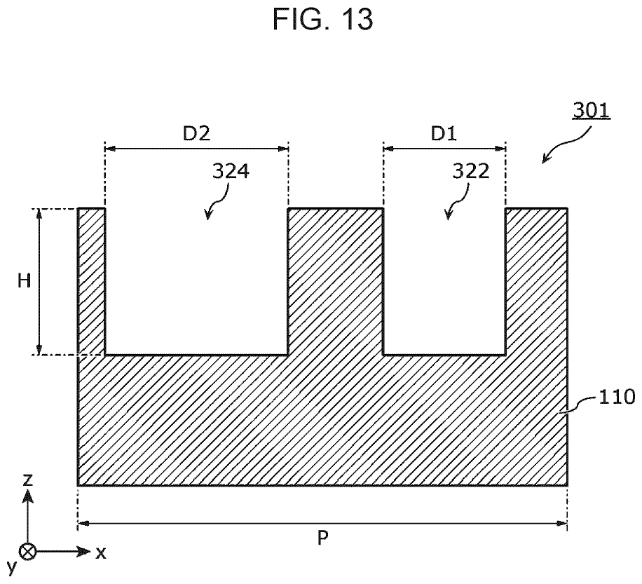

FIG. 12 is an enlarged plan view of an optical element 200 according to a first modification of the present embodiment. As with FIG. 2, FIG. 12 illustrates in an enlarged manner the optical element 200 including a plurality of microstructures.

As illustrated in FIG. 12, the optical element 200 includes, as the plurality of microstructures, first microstructures 222, second microstructures 224, and third microstructures 226. The plurality of microstructures are provided on a main surface of a substrate (not illustrated). Three first microstructures 222, three second microstructures 224, and three third microstructures 226 constitute one unit cell 201. A plurality of unit cells 201 are arranged in a matrix pattern to constitute the optical element 200.

The shape of the unit cell 201 in plan view is a square. In one unit cell 201, in plan view, the first microstructures 222, the second microstructures 224, and the third microstructures 226 are alternately arranged in a 3×3 matrix pattern. In plan view, three first microstructures 222 are arranged on one of the two diagonal lines of the unit cell 201. Two of the three second microstructures 224 are arranged diagonally along the diagonal line so as to parallel to the first microstructures 222 in the same unit cell 201. The remaining one of the three second microstructures 224 is disposed in line with two second microstructures 224 of an adjacent unit cell 201 (in a direction parallel to the diagonal line of the unit cell 201). Two of the three third microstructures 226 are arranged diagonally along the diagonal line so as to parallel to the first microstructures 222 in the same unit cell 201. The remaining one of the three third microstructures 226 is disposed in line with two third microstructures 226 of an adjacent unit cell 201 (in a direction parallel to the diagonal line of the unit cell 201).

To be more specific, when the unit cell 201 is equally divided into nine squares that are arranged in a 3×3 matrix pattern in plan view, the three first microstructures 222, the three second microstructures 224, and the three third microstructures 226 are arranged so that the geometrical centers (centroids) thereof coincide with the centers of the nine squares. Thus, when the plurality of unit cells 201 are arranged in a matrix pattern, the first microstructures 222, the second microstructures 224, and the third microstructures 226 are alternately arranged at equal arrangement periods in each of the x-axis direction and the y-axis direction. The plurality of second microstructures 224 are each disposed between adjacent first microstructures 222. Moreover, the plurality of third microstructures 226 are each disposed between the first microstructure 222 and the second microstructure 224 that are adjacent thereto.

The first microstructures 222, the second microstructures 224, and the third microstructures 226 are each a protrusion protruding from the main surface of the substrate. To be specific, the first microstructures 222, the second microstructures 224, and the third microstructures 226 are cylindrical bodies having circular bottom surfaces with different diameters (maximum widths).

The first microstructures 222, the second microstructures 224, and the third microstructures 226 differ from one another in at least one of shape, arrangement period and material. In the present modification, the first microstructures 222, the second microstructures 224, and the third microstructures 226 differ from one another in diameter. To be specific, the diameter of the second microstructures 224 is greater than the diameter of the first microstructures 222 and is smaller than the diameter of the third microstructures 226.

In the present modification, the first microstructure 222 generates a first phase difference in an incident light beam and emits the incident light beam as a first transmitted light beam. For example, the first phase difference is φ1−φin, where φ1 is the phase of the first transmitted light beam and pin is the phase of the incident light beam. The second microstructure 224 generates a second phase difference in an incident light beam and emits the incident light beam as a second transmitted light beam. For example, the second phase difference is φ2−φin, where φ2 is the phase of the second transmitted light beam. The third microstructure 226 generates a third phase difference in an incident light beam and emits the incident light beam as a third transmitted light beam. For example, the third phase difference is φ3−φin, where φ3 is the phase of the third transmitted light beam. In the present embodiment, the second phase difference differs from the first phase difference. The third phase difference differs from each of the first phase difference and the second phase difference. In other words, the phase φ3 of the third transmitted light beam differs from each of the phase φ2 of the second transmitted light beam and the phase φ1 of the first transmitted light beam.

In this way, with the optical element 200 according to the present modification, because the phases of the first transmitted light beam, the second transmitted light beam, and the third transmitted light beam differ from one another, different interferences occur in accordance with the combination of transmitted light beams. To be specific, three interferences, which are interference between the first transmitted light beam and the second transmitted light beam, interference between the second transmitted light beam and the third transmitted light beam, and interference between the third transmitted light beam and the first transmitted light beam, occur. Due to the occurrence of three interferences, it is possible to improve controllability of light transmittance. Thus, it is possible to increase the precision in setting the transmittance of the optical element 200 and to realize the optical element 200 that meets the demands of users and the like.

### Second Modification

FIG. 13 is a cross-sectional view of a unit cell 301 of an optical element according to a second modification of the present embodiment. The plan view of the unit cell 301 is the same as that of the unit cell 101 illustrated in FIG. 2.

As illustrated in FIG. 13, in the unit cell 301 according to the present modification, a plurality of microstructures are recesses. To be specific, an optical element according to the present modification includes, as a plurality of microstructures, first microstructures 322 that are recesses and second microstructure 324 that are recesses. The arrangement and the shapes of the first microstructures 322 and the second microstructures 324 are the same as those of the first microstructures 122 and the second microstructures 124 according to the embodiment.

When the microstructures are recesses as in the present modification, the refractive index of the microstructures is the same as that of air, and the refractive index of a region surrounding the microstructures is the same as that of the material of the substrate 110. Also in this case, because the phase of a transmitted light beam that passes through the microstructures, which are recesses, is represented by expression (2) described above, it is possible to cause interference similar to that of the embodiment. Accordingly, in the same way as the embodiment, it is possible to realize an optical element having small wavelength dependency.

In each of the cases where the microstructures are protrusions and recesses, the shape of the microstructures is not limited to a cylindrical body. For example, the shape of protrusions or recesses may be a columnar body other than a cylindrical body, a conical body, or a combination of a columnar body and a conical body. The columnar body may be a prism such as a quadrangular prism or a hexagonal prism, or may be an elliptic cylinder. The conical body may be a pyramid such as a quadrangular pyramid or a hexagonal pyramid, or may be a circular cone or an elliptic cone. Alternatively, the shape of protrusions or recesses may be a polygonal frustum, or may be a circular frustum or an elliptic frustum. When the shape is a prism, a pyramid, or a polygonal frustum, the bottom surface need not be a regular polygon.

### Other Embodiments

Heretofore, optical elements according to one or more aspects have been described based on embodiments. However, the present disclosure is not limited to these embodiments. Within the gist of the present disclosure, various modifications that are made on the present embodiment, and configurations that are constructed by combining constituent elements of different embodiments are also included in the scope of the present disclosure.

For example, in the embodiment described above, examples in which the side surfaces and the upper surfaces of the plurality of microstructures are exposed have been described. However, the side surfaces and the upper surfaces of the plurality of microstructures may be covered by another member having a refractive index different from that of the microstructures. For example, the space between the plurality of microstructures may be filled with another member having a refractive index different from that of the microstructures. Thus, it is possible to protect the plurality of microstructures. Moreover, by adjusting the refractive index of the other member, it is possible to adjust the optical characteristics of the optical element.

For example, in order to improve the transmittance, an anti-reflection (AR) function film may be additionally formed. Instead of or in addition to the AR function film, various light modulation layers having light modulation functions may be provided in the optical element 100.

For example, the substrate and the plurality of microstructures may be made of different materials. As long as it is possible to maintain the positional relationship among the plurality of microstructures, the optical element need not include a substrate.

For example, the plurality of microstructures may be provided on both surfaces of the substrate. For example, both of the plurality of first microstructures and the plurality of second microstructures may be provided on both surfaces of the substrate. Alternatively, the plurality of first microstructures may be provided on one of the main surfaces of the substrate, and the plurality of second microstructures may be provided on the other main surface of the substrate.

For example, the periodic arrangement of the first microstructures, the second microstructures, and the third microstructures is not limited to the example described above. For example, the plurality of first microstructures may be arranged in a quadrangular grid pattern, a triangular grid pattern, or a honeycomb grid pattern. The same applies to the plurality of second microstructures and the plurality of third microstructures. The plurality of first microstructures and the plurality of second microstructures may differ in arrangement rule.

An aspect of the present disclosure may be realized as a camera system or a sensor system including an optical element according to each of the aspects described above, a sensor that receives light that has passed through the optical element and photoelectrically converts the received light, and a signal processing circuit that processes an electric signal that is output from the sensor. Alternatively, an aspect of the present disclosure may be realized as an optical system including a light source and an optical element, according to each of the aspects described above, that transmits or reflects at least a part of light from the light source. The optical system is, for example, a projector, an illumination device, or the like, but is not limited to these.

Various modifications, replacement, addition, omission, and the like can be performed on the embodiments described above within the scope of the claims and the equivalents thereof.

The present disclosure is applicable to an optical element having a low wavelength dependency, which can be used as, for example, a filter, a lens, or the like of a camera, a light detection and ranging (LiDAR) sensor, a projector, an augmented reality (AR) display, a telescope, a microscope, a thermal image sensor, or the like.

What is claimed is:

1. An optical element comprising:
a substrate; and
a plurality of microstructures each of which is a protrusion on a main surface of the substrate, generates a phase difference in an incident light beam, and emits the incident light beam as a transmitted light beam,
wherein the plurality of microstructures is two-dimensionally arranged on the main surface in a first direction in which the plurality of microstructures is most closely adjacent to each other and in a second direction that intersects the first direction and in which the plurality of microstructures is most closely adjacent to each other,
wherein the plurality of microstructures includes
a first microstructure that generates a first phase difference in the incident light beam and emits the incident light beam as a first transmitted light beam, and
a second microstructure that differs from the first microstructure in shape and/or size, generates a second phase difference different from the first phase difference in the incident light beam, and emits the incident light beam as a second transmitted light beam,
wherein a plurality of first microstructures is two-dimensionally arranged at a predetermined arrangement period in each of the first direction and the second direction, a plurality of second microstructures is two-dimensionally arranged at the predetermined arrangement period in each of the first direction and the second direction, each of the plurality of first microstructures is the first microstructure, and each of the plurality of second microstructures is the second microstructure, and
wherein the second microstructure is disposed between two of the first microstructures in the first direction and the second direction and has a space between the second microstructure and the first microstructure adjacent thereto, and a center-to-center distance between the second microstructure and the first microstructure adjacent thereto is shorter than a wavelength of the incident light beam.

2. The optical element according to claim 1,
wherein the optical element causes the first transmitted light beam and the second transmitted light beam to interfere with each other by using a difference between the first phase difference and the second phase difference, and reduces a transmittance of the incident light beam.

3. The optical element according to claim 2,
wherein the transmittance is less than or equal to 10%.

4. The optical element according to claim 1,
wherein the first direction and the second direction are perpendicular to each other, and
wherein a distance between the second microstructure and the first microstructure adjacent thereto in the first direction and a distance between the second microstructure and the first microstructure adjacent thereto in the second direction are the same.

5. The optical element according to claim 1,
wherein
$$H \geq \frac{λ}{2 \vert {n}_{b} - {n}_{p} \vert}$$
is satisfied,
where H is a height of the plurality of microstructures, λ is a wavelength of the incident light beam, nₚ is a refractive index of the plurality of microstructures, and n_{b} is a refractive index of a region surrounding the plurality of microstructures.

6. The optical element according to claim 1,
wherein the plurality of microstructures is provided on a main surface through which the incident light beam is emitted from the substrate.

7. The optical element according to claim 1,
wherein a wavelength of the incident light beam is greater than or equal to 8 μm and less than or equal to 14 μm.

8. The optical element according to claim 7,
wherein an absorptance of the optical element with respect to the incident light beam is less than or equal to 5%.

9. The optical element according to claim 1,
wherein a shape of the protrusion is a columnar body, a conical body, or a combination of a columnar body and a conical body.

10. The optical element according to claim 1,
wherein the substrate and the plurality of microstructures are made of the same material and include, as a main component, one or more selected from the group consisting of silicon, germanium, chalcogenide, chalcohalide, zinc sulfide, zinc selenide, fluoride, thallium halide, sodium chloride, potassium chloride, potassium bromide, cesium iodide, and plastic.

11. The optical element according to claim 1,
wherein the plurality of microstructures is provided on a main surface of a silicon substrate whose crystal orientation is (100), (110), or (111).

12. The optical element according to claim 1,
wherein a difference between the first phase difference and the second phase difference is 180°.

13. The optical element according to claim 1,
wherein a diameter of the first microstructure and the second microstructure is shorter than ½ of the predetermined arrangement period.

14. The optical element according to claim 1,
wherein the plurality of microstructures further includes
a third microstructure that differs from each of the first microstructure and the second microstructure in shape and/or size, generates a third phase difference different from each of the first phase difference and the second phase difference in the incident light beam, and emits the incident light beam as a third transmitted light beam,
wherein a plurality of third microstructures is two-dimensionally arranged at the predetermined arrangement period in each of the first direction and the second direction, and each of the plurality of third microstructures is the third microstructure, and
wherein the third microstructure is disposed between the first microstructure and the second microstructure in the first direction and the second direction and has a space between the third microstructure and the first microstructure adjacent thereto and a space between the third microstructure and the second microstructure adjacent thereto, and a center-to-center distance between the third microstructure and the first microstructure adjacent thereto and a center-to-center distance between the third microstructure and the second microstructure adjacent thereto are shorter than a wavelength of the incident light beam.

15. The optical element according to claim 14,
wherein the optical element causes the first transmitted light beam, the second transmitted light beam, and the third transmitted light beam to interfere with one another by using differences among the first phase difference, the second phase difference, and the third phase difference, and reduces a transmittance of the incident light beam.

16. An optical element comprising:
a substrate; and
a plurality of microstructures each of which is a recess on a main surface of the substrate, generates a phase difference in an incident light beam, and emits the incident light beam as a transmitted light beam,
wherein the plurality of microstructures is two-dimensionally arranged on the main surface in a first direction in which the plurality of microstructures are most closely adjacent to each other and in a second direction that intersects the first direction and in which the plurality of microstructures is most closely adjacent to each other,
wherein the plurality of microstructures includes
a first microstructure that generates a first phase difference in the incident light beam and emits the incident light beam as a first transmitted light beam, and
a second microstructure that differs from the first microstructure in shape and/or size, generates a second phase difference different from the first phase difference in the incident light beam, and emits the incident light beam as a second transmitted light beam,
wherein a plurality of first microstructures is two-dimensionally arranged at a predetermined arrangement period in each of the first direction and the second direction, a plurality of second microstructures is two-dimensionally arranged at the predetermined arrangement period in each of the first direction and the second direction, each of the plurality of first microstructures is the first microstructure, and each of the plurality of second microstructures is the second microstructure, and
wherein the second microstructure is disposed between two of the first microstructures in the first direction and the second direction and is connected to the first microstructure adjacent thereto, and a center-to-center distance between the second microstructure and the first microstructure adjacent thereto is shorter than a wavelength of the incident light beam.
